(19) United States
(12) Patent Application Publication
(10) Pub. No.: US 2013/0346892 A1
(43) Pub. Date: Dec. 26, 2013

(54) GRAPHICAL USER INTERFACE ELEMENT EXPANSION AND CONTRACTION USING A ROTATING GESTURE

(71) Applicant: Google Inc., Mountain View, CA (US)

(72) Inventors: Christopher Richard Wren, Arlington, MA (US); Daniel Robert Sandler, Burlington, MA (US)

(73) Assignee: Google Inc., Mountain View, CA (US)

(21) Appl. No.: 13/890,032

(22) Filed: May 8, 2013

Related U.S. Application Data
(60) Provisional application No. 61/664,087, filed on Jun. 25, 2012.
(60) Provisional application No. 61/788,351, filed on Mar. 15, 2013.

(51) Int. Cl. G06F 3/01

(52) U.S. Cl. CPC G06F 3/017
USPC 715/765

(57) ABSTRACT

A computing device outputs a graphical user interface (GUI) for display at a display device. The GUI includes a first version of the element. The computing device receives an indication of a user input. In response to determining that the user input corresponds to a gesture that includes a rotating movement of an input point relative to a fixed region, the computing device outputs, for display at the display device, a second version of the element in place of the first version of the element. The second version of the element is larger than the first version of the element.

### RELATED APPLICATION

This application claims the benefit of priority to U.S. Provisional Patent Application No. 61/664,087, filed Jun. 25, 2012, and U.S. Provisional Patent Application No. 61/788,351, filed Mar. 15, 2013, the entire contents of which are hereby incorporated by reference.

### BACKGROUND

Some computing devices include presence-sensitive input devices that detect the presence of input objects (such as fingers or styli) to process user input. For example, a computing device may include a touchscreen that detects a touch input from a user finger or stylus. Users may operate such computing devices in various ways. For example, a user may operate a particular mobile computing device, such as a smartphone or a tablet computer, by cradling the smartphone or tablet computer in the palm of the user's hand, or by placing the device on a flat surface located in front of the user, and providing a presence input using one or more fingers of the user's free hand.

In some instances, a user may find it awkward or laborious to provide a presence input in order to perform certain gestures used to manipulate elements within a graphical user interface (GUI) displayed, e.g., on a presence-sensitive display of a mobile computing device. For example, the user may find it awkward or laborious to perform a so-called “pinching” gesture to manipulate (e.g., expand or collapse) a particular element within the GUI.

### SUMMARY

In one example, a method includes outputting, by a computing device and for display, a graphical user interface (GUI) that includes a first version of an element. The method further includes receiving, by the computing device, an indication of a user input. The method also includes, in response to determining that the user input corresponds to a gesture that includes a rotating movement of an input point relative to a fixed region, outputting, by the computing device and for display, a second version of the element in place of the first version of the element. The second version of the element is larger than the first version of the element.

In another example, a computing device includes one or more processors configured to output a GUI for display. The GUI includes at least a first version of an element. The one or more processors are further configured to receive an indication of a user input. The one or more processors are still further configured to determine that the user input corresponds to a particular gesture that comprises a rotating movement of an input point relative to a fixed region. The one or more processors are also configured to, in response to determining that the user input corresponds to the rotating movement of the input object relative to the fixed region, output, for display, a second version of the element in place of the first version of the element. The second version of the element is larger than the first version of the element in at least one of: a vertical direction, a horizontal direction, and a diagonal direction.

In another example, a non-transitory computer-readable storage medium includes instructions that, when executed by one or more processors of a computing device, cause the computing device to output, for display, a GUI that includes a first version of an element. Execution of the instructions further causes the computing device to receive an indication of a first user input. The first user input corresponds to a first rotating movement of a first input point relative to a first fixed region in a first direction. Execution of the instructions still further causes the computing device to output, in response to receiving the indication of the first user input and for display, a second version of the element in place of the first version of the element. The second version of the element has a size that is greater than a size of the first version of the element. Execution of the instructions also causes the computing device to receive, after outputting the second version of the element, an indication of a second user input. The second user input corresponds to a second rotating movement of a second input point relative to a second fixed region in a second direction. Execution of the instructions also causes the computing device to output, in response to receiving the indication of the second user input and for display, the first version of the element in place of the second version of the element.

The details of one or more examples of this disclosure are set forth in the accompanying drawings and the description below. Other features, objects, and advantages of the disclosure will be apparent from the description, drawings, and claims.

### BRIEF DESCRIPTION OF DRAWINGS

FIG. 1 is a conceptual diagram illustrating an example computing device that outputs a graphical user interface (GUI) for display at a display device, in accordance with one or more aspects of this disclosure.

FIG. 2 is a block diagram illustrating an example configuration of the computing device of FIG. 1, in accordance with one or more aspects of this disclosure.

FIG. 3 is a block diagram illustrating an example in which the computing device of FIG. 1 outputs graphical content for display by one or more remote display devices, in accordance with one or more aspects of this disclosure.

FIGS. 4A-4C are conceptual diagrams illustrating example GUIs that the computing device of FIG. 1 may output for display at the display device, in accordance with one or more aspects of this disclosure.

FIG. 5 is a flowchart illustrating an example process that the computing device of FIG. 1 may in perform, in accordance with one or more aspects of this disclosure.

FIG. 6 is a flowchart illustrating another example process that the computing device of FIG. 1 may in perform, in accordance with one or more aspects of this disclosure.

### DETAILED DESCRIPTION

In general, techniques of this disclosure are directed to presence-based input (e.g., touch input, and/or touchless gesture input) for computing devices. A computing device may output a graphical user interface (GUI) for display by a display device (such as a presence-sensitive display). The GUI may include a variety of objects and information, including one or more interface elements, some of which may be expanded and collapsed to display more or less information. For example, some interface elements may include user notifications, such as notifications of device activity, status, incoming/received communications, calendar notifications, and the like. These interface elements may have, for example, rectangular geometries each defined by a width and a height. Additionally, some interface elements may vary in size depending on a size of the display device and the information included within the interface elements, sometimes making it difficult for a user to expand or collapse the interface elements to see more or less information included in the interface elements.

Techniques of this disclosure may provide one or more potential advantages compared to other user interfaces that include notification functionality. As one example, to expand or collapse a particular relatively narrow interface element (e.g., an interface element displayed using a graphical element having a relatively short height, width, or equivalent dimension), it may be difficult or impractical for a user to place two or more input objects (e.g., fingers or styli) within a region corresponding to the interface element (e.g., a region of a presence-sensitive display device that displays the interface element), so as to perform a given expansion or collapsing (i.e., contraction) gesture. Instead, according to the techniques disclosed herein, to expand or collapse the interface element, the user may perform a gesture that includes a rotating movement of one or more input points relative to a fixed region. For example, the user may perform the gesture within, or outside of (e.g., proximate to), a region that corresponds to the interface element. In some examples, the region that corresponds to an interface element is a region of a presence-sensitive display that displays the interface element. In other examples, the region may be a point in 2-dimensional or 3-dimensional space that the computing device associates with the interface element. As a result, the computing device may receive an indication of the gesture and expand or collapse the interface element in response to the gesture. For example, the computing device may output an updated GUI such that the interface element is either expanded or collapsed, depending on a previous state of the interface element and a direction of rotation of the gesture. As such, the disclosed techniques may potentially afford the user flexibility in accurate placement of a finger, stylus, etc., with respect to the location and dimensions of the interface element.

As one example, a computing device may output, for display, a GUI that includes an interface element. The computing device may output the interface element at an increased or decreased size in response to receiving an indication of a rotating gesture. The rotating gesture may comprise a rotation of one or more input objects (e.g., fingers, styli, etc.) at least a part of the way around a fixed point or region. The fixed point or region may be on a display device. In this example, the movement of the input objects may be analogous to a movement of a tip of a so-called “flat-head” screwdriver when turning a screw.

In this manner, the techniques of this disclosure may enable a user to more easily instruct the computing device to increase or decrease one or more interface elements of a GUI, especially in cases where the interface elements have a relatively short height and/or a relatively long width, a relatively short width and/or a relatively long height, or any dimension that is relatively short with respect to another, relatively longer dimension. For example, in such cases, performing other expansion or collapsing gestures (e.g., two-finger “pinch-out” gestures, or equivalent gestures) that require placement of two or more fingers or styli within the relatively short height, width, or other dimension of a particular graphical element used to represent a given interface element, may be difficult or impractical.

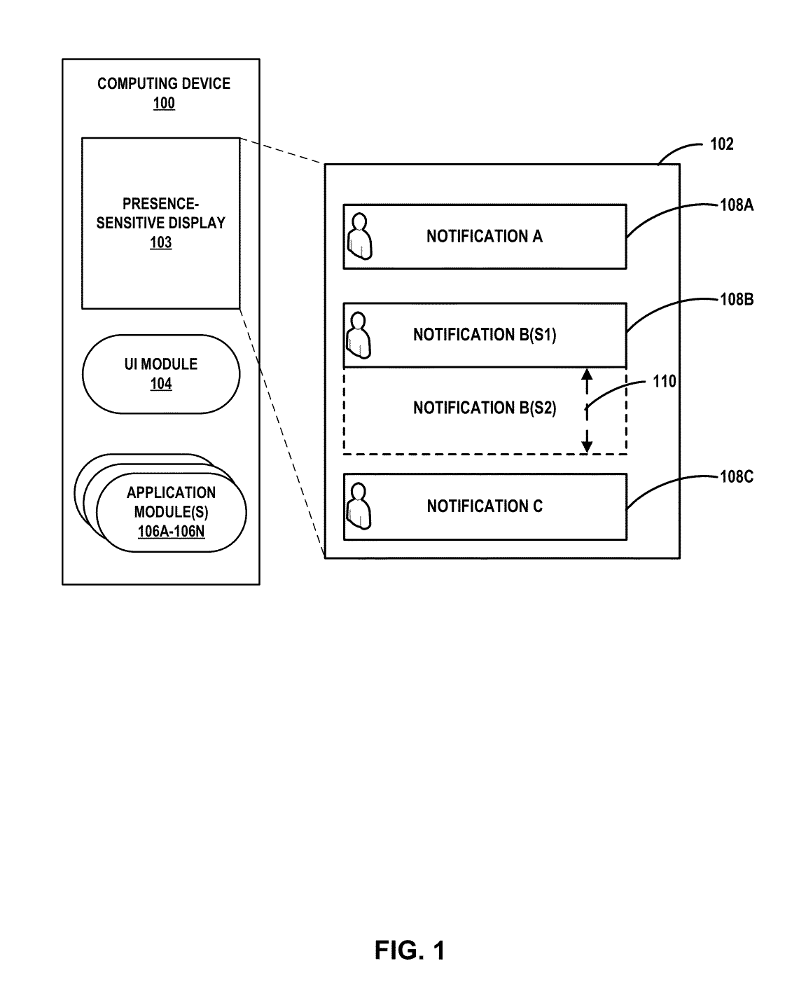

FIG. 1 is a conceptual diagram illustrating an example computing device 100 that outputs a GUI for display at a presence-sensitive display, in accordance with one or more aspects of this disclosure. Computing device 100 may include, be, or be a part of, one or more of a variety of types of devices, such as mobile phones (including smartphones), tablet computers, netbooks, laptops, personal digital assistants (“PDAs”), watches, and/or other types of devices. In other examples, computing device 100 may be one or more of other types of computing devices, such as desktop computers, point of sale devices, televisions, gambling devices, appliances, in-car computers, and other types of computing devices. In still other examples, computing device 100 may be one or more processors, e.g., one or more processors of one or more of the computing devices described above.

In the example of FIG. 1, computing device 100 includes a presence-sensitive display 103, a user interface (UI) module 104, and one or more application module(s) 106A-106N (collectively, “application module(s) 106”). Application module(s) 106 may configure computing device 100 to provide applications, such as “apps,” or other computer programs. UI module 104 may receive indications of user input detected by presence-sensitive display 103 from presence-sensitive display 103, and may provide the indications, or data based at least in part from such indications, to application module(s) 106. Application module(s) 106 may process the indications or data and provide output data to UI module 104. UI module 104 may process the output data from application module(s) 106 and may cause computing device 100 to output additional data for display at presence-sensitive display 103.

In the example of FIG. 1, computing device 100 outputs a GUI 102 for display at presence-sensitive display 103 built into computing device 100. In other examples, computing device 100 may output GUI 102 for display at a presence-sensitive display that is operatively or communicatively coupled to computing device 100. Presence-sensitive display 103 may be implemented in various ways. For example, presence-sensitive display 103 may be implemented using a resistive touchscreen, a surface acoustic wave (SAW) touchscreen, a capacitive touchscreen, a projective capacitance touchscreen, an acoustic pulse recognition touchscreen, or another touchscreen technology. In some examples, presence-sensitive display 103 may be able to detect the presence of an input object without the input object physically touching presence-sensitive display 103. Rather, in some such examples, presence-sensitive display 103 may be able to detect the presence of the input object when the input object is sufficiently close to presence-sensitive display 103.

In accordance with the techniques of this disclosure, computing device 100 may output, for display, a first version of an interface element. In response to receiving an indication of a user input entered that corresponds to a rotating movement of one or more input points relative to a fixed region, output a second version of an interface element in place of the first version interface element. The second version of the interface element may be differently sized (i.e., larger or smaller) than the first version of the interface element. For instance, the second version of the interface element may be larger or smaller than the first version of the interface element in at least one of a vertical direction, a horizontal direction, and a diagonal direction.

For ease of explanation, this disclosure may refer to a gesture that includes a rotating movement of one or more input points relative to a fixed region on presence-sensitive display 103 as a “rotating gesture.” An input point may be a spatial point or region at which presence-sensitive display 103 detects a presence of an input object, such as finger or a stylus. Furthermore, because different versions of an interface element may include related content, and because the versions of an interface element may be differently sized, this disclosure may describe the act of replacing a first version of an interface element with a second version of the interface element as expanding or collapsing the interface element.

In the example of FIG. 1, GUI 102 includes interface elements 108A-108C (collectively, “interface elements 108”). Interface elements 108 may include various data. In the example of FIG. 1, interface elements 108 include notifications to a user of computing device 100 (i.e., “user notifications”). Specifically, interface elements 108A, 108B, and 108C include “notification A,” “notification B,” and “notification C,” respectively. In other examples, interface elements 108 may contain data other than user notifications. In some examples, GUI 102 may include interface elements in addition to interface elements 108. For instance, GUI 102 may include text and/or graphical interface elements, such as icons, images, photos, status bars, battery gauges, wireless signal strength gauges, and so on.

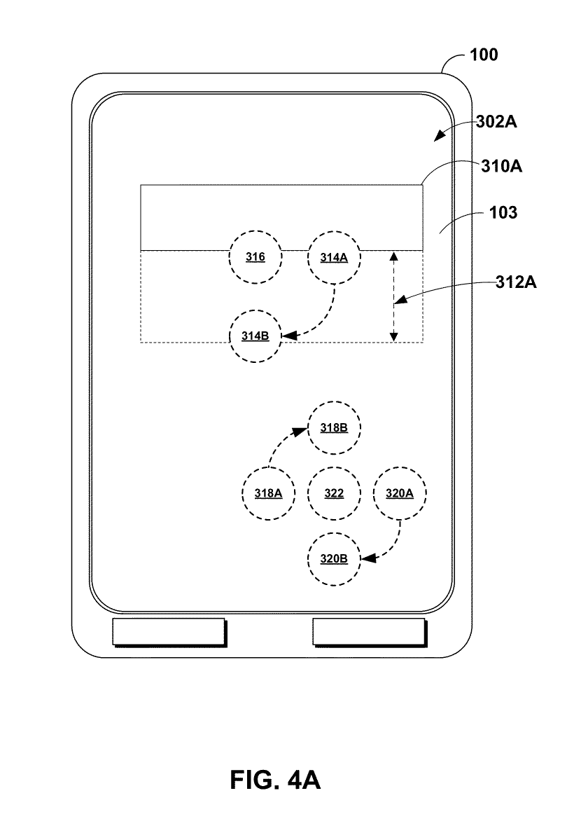

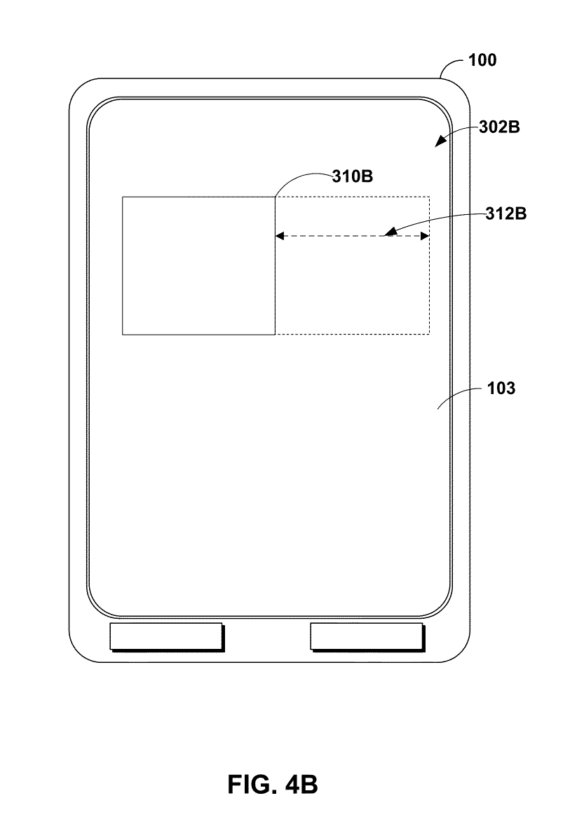

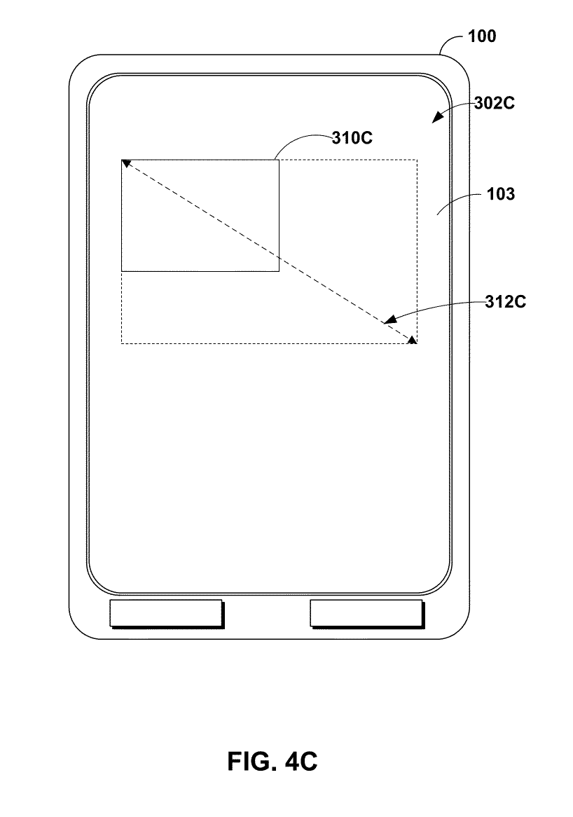

Computing device 100 may output interface elements 108 in expanded and/or collapsed states in response receiving indications of user input (e.g., entered at presence-sensitive display 103) that correspond to rotating gestures. For instance, in the example of FIG. 1, interface element 108B may expand or collapse in a direction indicated by arrow 110 (i.e., in an upward/downward direction). In some examples, interface elements 108A and 108B may expand and/or collapse in a same direction as the direction indicated by arrow 110. In other examples, interface elements 108 may expand and/or collapse in other directions (e.g., in a left/right direction, or in a diagonal direction), as explained in greater detail below with reference to FIGS. 4B-4C.

In the example of FIG. 1, interface element 108B is in an expanded state. When interface element 108B is in the expanded state, interface element 108B includes a first content portion of notification B and a second content portion of notification B. In the example of FIG. 1, “S1” indicates the first content portion of notification B, and “S2” indicates the second content portion of notification B. When interface element 108B is in the collapsed state, interface element 108B exclusively includes the first content portion S1 of notification B. Furthermore, interface element 108B is smaller when interface element 108B is in the collapsed state than when interface element 108B is in the expanded state.

As mentioned above, computing device 100 may output an interface element of GUI 102 in expanded and/or collapsed states in response to determining that an indication of a user input corresponds to a rotating gesture. In various examples, computing device 102 may determine that various indications of user inputs correspond to rotating gestures. For example, computing device 100 may receive an indication of a first input point remaining substantially at a fixed region (e.g., on presence-sensitive display 103), while a second input point rotates relative to the fixed region. In some examples, the second input point may rotate from a region that corresponds to the interface element to another region. In other examples, the second input point may rotate within a region that corresponds to the interface element.

In other examples, computing device 100 may determine that an indication of user input corresponds to a rotating gesture if computing device 100 receives an indication that both a first input point and a second input point rotate relative to a fixed region. As one example, one or more of the first input point and the second input point may rotate from a region that corresponds to the interface element to another region. As another example, one or more of the first input point and the second input point may rotate within a region that corresponds to the interface element.

In these examples, when an input point rotates with respect to a fixed region, the input point may follow a generally arc-shaped path that may maintain a consistent distance from the fixed region. In some examples, computing device 100 may determine that a user input corresponds to a rotating gesture if the corresponding input point has rotated though various angles. For instance, computing device 100 may determine that a user input corresponds to a rotating gesture if the corresponding input point has rotated 45°, 70°, or 90° relative to a fixed region (e.g., with respect to a starting position of the input point). In some examples, computing device 100 may determine that a user input corresponds to a rotating gesture even if the arc-shaped path of the input point is flattened into a line that is generally straight.

In some examples, the fixed region may be within a region that corresponds to a particular interface element that the user wants computing device 100 to expand or collapse. In other examples, however, the fixed region may be outside of the region that corresponds to the particular interface element. For example, the fixed region may be outside of, but proximate to (e.g., near, or on a boundary of) the region that corresponds to the particular interface element. Additionally, in some examples, the rotating movement of the input point relative to the fixed region may be in one of a clockwise direction and a counterclockwise direction.

Moreover, in some examples, computing device 100 may receive indications of additional (e.g., subsequent) user inputs that may correspond to rotating gestures. In response, computing device 100 may output an expanded interface element in a collapsed state or output a collapsed interface element in an expanded state. For example, computing device 100 may receive an indication of a first user input. In response to determining that the first user input corresponds to a gesture that includes a rotating movement of a first input point relative to a first fixed region, computing device 100 may output, for display, a second interface element in place of a first interface element. In this example, the second interface element may be differently sized (e.g., larger) than the first interface element. Furthermore, in this example, computing device 100 may receive an indication of a second user input. In response to determining that the second user input corresponds to a gesture that includes a rotating movement of a second input point relative to a second fixed region, computing device 100 may output, for display, the first interface element in place of the second interface element. In this example, the second input point may rotate relative to the second fixed region in a direction that is reversed relative to a direction in which the first input point rotates relative to the first fixed region. Furthermore, in this example, the first fixed region and the second fixed region may be, or include, a same region or different regions of presence-sensitive display 103. Additionally, in this example, the first input point and the second input point may be a same input point, or different input points. If the first and second input points are the same input point, the rotating movement of the second input point may be a continuation of the rotating movement of the first input point.

In this manner, computing device 100 may be configured to implement the techniques of this disclosure that relate to GUI element expansion and contraction using a rotating gesture. As previously described, the techniques may enable a user to more easily expand or collapse one or more interface elements of a GUI, especially in cases where the sizes of the interface elements make performing other gestures to expand or collapse the interface elements difficult or impractical.

In particular, computing device 100 represents an example of a computing device that may include one or more processors configured to output a GUI for display (e.g., at a presence-sensitive display). For example, the GUI may include at least a first version of an element. The one or more processors may be further configured to receive an indication of a user input (e.g., from the presence-sensitive display). In this example, the one or more processors may be still further configured to determine that the user input corresponds to a particular gesture. For example, the particular gesture may include a rotating movement of an input point relative to a fixed region (e.g., on the presence-sensitive display). Also in this example, the one or more processors may also be configured to, in response to determining that the user input corresponds to the particular gesture, output, for display (e.g., at the presence-sensitive display), a second version of the element in place of the first version of the element. For example, the second version of the element may be larger than the first version of the element in at least one of: a vertical direction, a horizontal direction, and a diagonal direction.

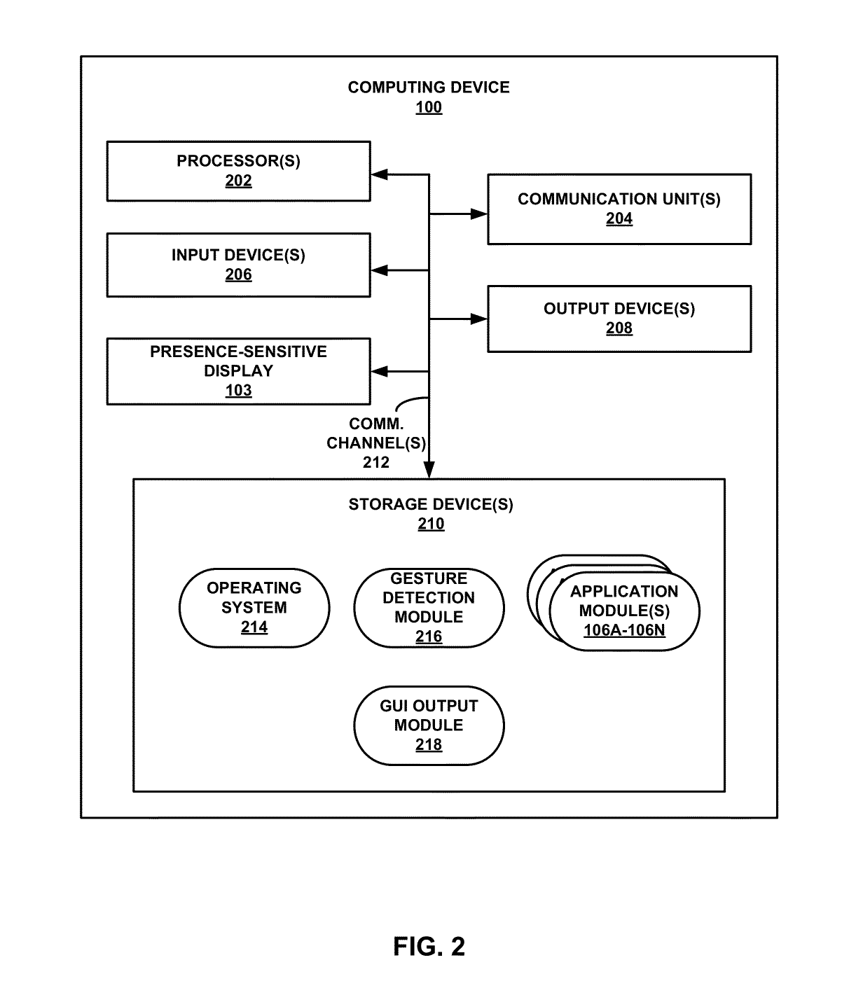

FIG. 2 is a block diagram illustrating an example configuration of computing device 100 of FIG. 1, in accordance with one or more aspects of this disclosure. Although FIG. 2 and the subsequent figures are described with reference to computing device 100, the techniques of this disclosure are not limited to the example of FIG. 1.

As shown in the example of FIG. 2, computing device 100 includes one or more processor(s) 202, one or more communication unit(s) 204, one or more input device(s) 206, one or more output device(s) 208, one or more presence-sensitive display 103, and one or more storage device(s) 210. In the example of FIG. 2, the various components of computing device 100 described above are interconnected via one or more communication channel(s) 212 (e.g., one or more signals, or signal “busses,” or communication interfaces). As also shown in the example of FIG. 2, storage device(s) 210 of computing device 100 further include at least one operating system 214, at least one gesture detection module 216, at least one GUI output module 218, and at least one application module(s) 106A-106N.

Processor(s) 202 may be configured to implement functionality and/or process instructions for execution within computing device 100. For example, processor(s) 202 may process instructions stored in one or more memory device(s) also included in computing device 100, and/or instructions stored on storage device(s) 210. Such instructions may include components of operating system 214, gesture detection module 216, GUI output module 218, and application module(s) 106A-106N, of computing device 100. Computing device 100 may also include one or more additional components not shown in FIG. 2, such as a global positioning system (GPS) receiver, and a radio frequency identification (RFID) reader, among other components, as well as one or more additional processors, memories (or memory devices), communication units (or network interfaces), storage devices, input devices, output devices, power sources, operating systems, and application modules.

In some examples, computing device 100 may use communication unit(s) 204, which may also be referred to as a network interface, to communicate with other devices via one or more networks, such as one or more wired or wireless networks. Communication unit(s) 204 may include a network interface card, such as an Ethernet card, an optical transceiver, a radio frequency transceiver, or any other type of device that can send and receive information. Other examples of communication unit(s) 204 may include Bluetooth®, 3G, 4G, and WiFi® radios in mobile computing devices, as well as a universal serial bus (USB) interface. In some examples, computing device 100 may use communication unit(s) 204 to wirelessly communicate with other, e.g., external, devices over a wireless network.

Although not shown in FIG. 2, computing device 100 may also include one or memories, or memory device(s), that may be configured to store information within computing device 100 during operation. The memory device(s) may include a computer-readable storage medium (e.g., such as a tangible computer-readable storage medium, a non-transitory computer-readable storage medium, a computer-readable storage device, or another medium or device). In some examples, the memory device(s) may include a temporary memory, meaning that a primary purpose of the memory device(s) may not be long-term storage. Furthermore, in other examples, the memory device(s) may include volatile memory, meaning that the memory devices may not maintain stored contents when the memory device(s) are not receiving power. Examples of volatile memories include random access memories (RAM), dynamic random access memories (DRAM), static random access memories (SRAM), and other forms of volatile memories known in the art. In some examples, the memory devices may store program instructions for execution by processor(s) 202. The memory devices may be used by software (e.g., operating system 214) or applications (e.g., one or more of gesture detection module 216, GUI output module 218, and application module(s) 106A-106N) executing on computing device 100 to temporarily store information during program execution.

Storage device(s) 210 may also include one or more computer-readable storage media. Storage device 210 may be configured to store greater amounts of information than the one or more memory devices described above. For example, storage device 210 may be configured for long-term storage of information. In some examples, storage device 210 may include non-volatile storage elements. Examples of such non-volatile storage elements include magnetic hard discs, optical discs, solid state discs, floppy discs, flash memories, forms of electrically programmable memories (e.g., electrically programmable read only memories (ROMs), or “EPROMs”), or electrically erasable and programmable memories (e.g., electrically erasable and programmable ROMs, or “EEPROMs”), as well as other forms of non-volatile memories known in the art. Input device(s) 206 may receive input from a user through tactile, audio, video, or biometric channels. Examples of input device(s) 206 may include a keyboard, mouse, touchscreen, presence-sensitive display, microphone, one or more still and/or video cameras, fingerprint reader, retina scanner, or any other device capable of detecting an input from a user or other source, and relaying the input to computing device 100 or components thereof. Output device(s) 208 may be configured to provide output to a user through visual, auditory, or tactile channels. Output device(s) 208 may include a video graphics adapter card, a liquid crystal display (LCD) monitor, a light emitting diode (LED) monitor, a cathode ray tube (CRT) monitor, a sound card, a speaker, or any other device capable of generating output that may be intelligible to a user. Input device(s) 206 and/or output device(s) 208 may also include a discrete touchscreen and a display, or a touchscreen-enabled display, a presence-sensitive display, or other input/output (I/O) capable displays known in the art.

Operating system 214 may control one or more functionalities of computing device 100 and/or components thereof. For example, operating system 214 may interact with gesture detection module 216, GUI output module 218, and application module(s) 106A-106N, and may facilitate one or more interactions between gesture detection module 216, GUI output module 218, and application module(s) 106A-106N and processor(s) 202, the one or more memory devices described above, input device(s) 206, output device(s) 208, presence-sensitive display 103, and storage device(s) 210. As shown in FIG. 2, operating system 214 may interact with, or be otherwise coupled to, application module(s) 106A-106N, gesture detection module 216, and GUI output module 218, also included within storage device(s) 210. In these and other examples, one or more of gesture detection module 216 and GUI output module 218 may be part of application module(s) 106A-106N, and/or of UI module 104 previously described with reference to FIG. 1. In some such instances, computing device 100 may use communication unit(s) 204 to access and implement the functionalities provided by computing device 100 and its components, through methods commonly known as “cloud computing.”

In general, computing device 100 may include any combination of one or more processors, one or more digital signal processors (DSPs), one or more field programmable gate arrays (FPGAs), one or more application specific integrated circuits (ASICs), and one or more application-specific standard products (ASSPs). Computing device 100 may also include memory, or memory devices, both static (e.g., hard drives or magnetic drives, optical drives, FLASH memory, programmable ROM, or “PROM”), EPROM, EEPROM, etc.) and dynamic (e.g., RAM, DRAM, SRAM, etc.), or any other non-transitory computer-readable storage medium capable of storing instructions that cause the one or more processors or other devices or hardware to perform the GUI element expansion and contraction techniques described herein. Thus, computing device 100 may represent hardware, or a combination of hardware and software, to support the below-described components, modules, or elements, and the techniques should not be strictly limited to any particular embodiment described below.

As one example, GUI output module 218 may output a GUI (e.g., GUI 102 of FIG. 1) for display at presence-sensitive display 103 or another one or output device(s) 208. In some examples, presence-sensitive display 103 and/or one or more of output device(s) 208 may be operatively coupled to computing device 100. For example, presence-sensitive display 103 may be included within, or be otherwise integrated with, one or more of input device(s) 206 and output device(s) 208 of computing device 100. In other examples, presence-sensitive display 103 may be communicatively coupled to computing device 100, e.g., via one or more of input device(s) 206 and output device(s) 208, and/or via communication unit(s) 204, or using other means. For example, the GUI may include a first version of an interface element (e.g., any of interface elements 108 of FIG. 1). In some examples, the GUI initially output by GUI output module 218 may correspond to an update of a GUI previously output by GUI output module 218, e.g., including updates or changes made as a result of a previous user gesture or user input, generally, entered at presence-sensitive display 103, or another content or information update by computing device 100.

In this example, gesture detection module 216 may further receive an indication of a user input entered at presence-sensitive display 103. Gesture detection module 216 may still further determine that the user input corresponds to a particular gesture. In this example, the particular gesture may include a rotating movement of an input point relative to a fixed region on presence-sensitive display 103. Subsequently, based on, or in response to, determining that the user input corresponds to such a gesture, GUI output module 218 may output (e.g., via output device(s) 208) for display at presence-sensitive display 103, a second version of the interface element in place of the first version of the interface element. In this example, the second version of the interface element may be larger than the first version of the interface element.

To perform the above-described operations, in some examples, gesture detection module 216 (or another module of application module(s) 106A-106N) may monitor, or “listen for,” input events generated by operating system 214. For example, operating system 214 may receive data from presence-sensitive display 103, e.g., from a driver for presence-sensitive display 103 also included within storage device(s) 210. In response to receiving the data, operating system 214 may generate one or more input events. Gesture detection module 216 (or another module of application module(s) 106A-106N) may, in turn, process and respond to the one or more input events. For example, gesture detection module 216 (via GUI output module 218, or another module of application module(s) 106A-106N) may use an application programming interface (API) of operating system 214 to output data (e.g., an updated GUI) for display at presence-sensitive display 103, in response to the one or more input events.

As one particular example, gesture detection module 216 may monitor input events generated by operating system 214. Furthermore, GUI output module 218 may monitor input events generated by gesture detection module 216. In this example, gesture detection module 216 may determine whether an input indicated by one or more input events generated by operating system 214 corresponds to a rotating gesture. If the input corresponds to such a gesture, gesture detection module 216 may generate one or more input events of its own, and GUI output module 218, or one or more of application module(s) 106A-106N, may receive these input events. For example, in response to the one or more input events generated by gesture detection module 216, GUI output module 218 or the one or more of application module(s) 106A-106N may output data, such as an updated GUI, for display at presence-sensitive display 103.

In some examples, gesture detection module 216 may receive additional (e.g., subsequent) indications of user input detected by presence-sensitive display 103. For example, gesture detection module 216 may receive indications of other user inputs, and determine that these other user inputs also correspond to rotating gestures detected by presence-sensitive display 103. In particular, in cases where the above-described user input is a first user input, the above-described input point is a first input point, and the above-described fixed region is a first fixed region, gesture detection module 216 may further receive an indication of a second user input entered at presence-sensitive display 103. In this example, gesture detection module 216 may still further determine whether the second user input corresponds to a gesture that includes a rotating movement of a second input point relative to a second fixed region on presence-sensitive display 103. Also in this example, in response to determining that the second user input corresponds to such a gesture, GUI output module 218 may also output, for display at presence-sensitive display 103, the first version of the interface element in place of the second version of the interface element.

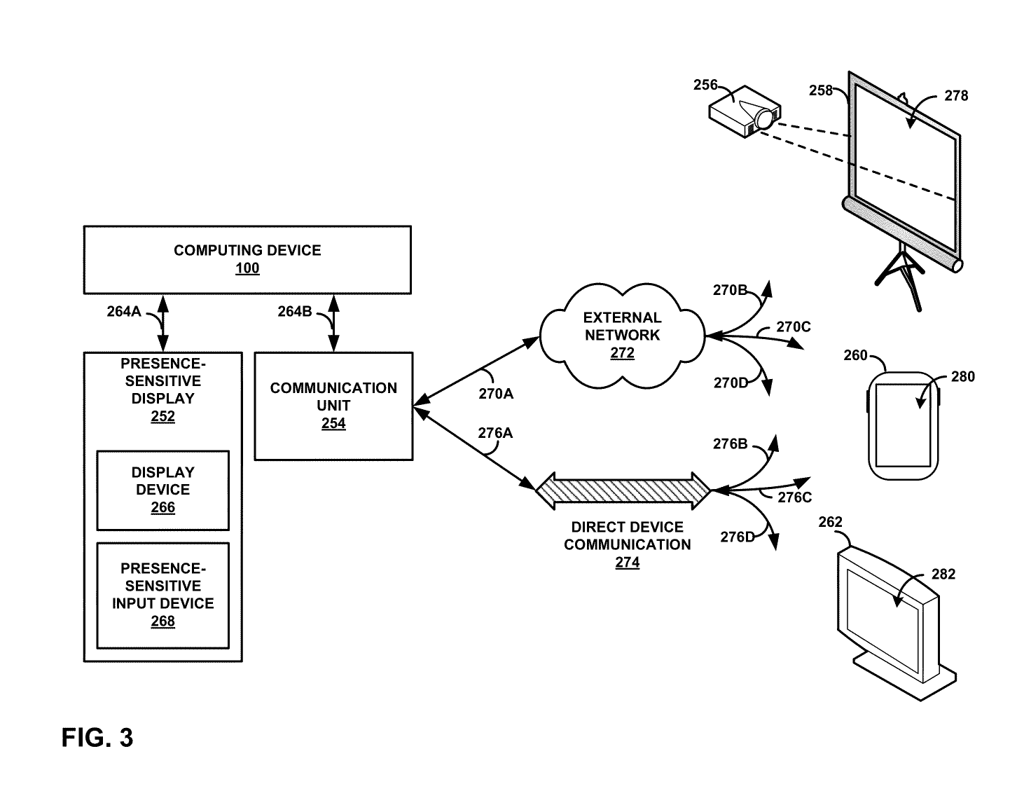

FIG. 3 is a block diagram illustrating an example computing device 100 that outputs data for display at one or more remote devices, in accordance with one or more techniques of the present disclosure. The one or more remote devices may display graphical content based on the data output by computing device 100. In general, graphical content may include any visual information that may be output for display, such as text, images, a group of moving images, etc. In some examples, computing device 100 may output data, such as Hypertext Markup Language (HTML) data, that a remote device may render to generate graphical content displayed by the remote device. In other examples, computing device 100 may output digital or analog signals that a remote device may use to generate graphical content displayed by the remote device.

In the example of FIG. 3, computing device 100 is operatively coupled to a presence-sensitive display 252 and a communication unit 254. Furthermore, in the example of FIG. 3, the one or more remote devices include a projector 256, a projection screen 258, a mobile device 260, and a visual display device 262. Computing device 100 may include and/or be operatively coupled to one or more other devices, e.g., input devices, output devices, memory, storage devices, etc. that are not shown in FIG. 3 for purposes of brevity and illustration.

Computing device 100 may be a processor that has the functionality described above with respect to processor(s) 202 (FIG. 2). For instance, computing device 100 may be a microprocessor, ASIC, or another type of integrated circuit configured to implement the techniques of this disclosure. In other examples, such as those illustrated in FIGS. 1 and 2, computing device 100 may be a stand-alone computing device that includes or is operatively coupled to a presence-sensitive display. In such examples, computing device 100 may be a desktop computer, a tablet computer, a smart television platform, a camera, a personal digital assistant (PDA), a server device, a mainframe computer, a telephone, a portable gaming device, a personal media player, a remote control device, a wearable computing device, or another type of computing device. In this disclosure, a first device may be said to be operatively coupled to a second device if the operations of the first and second devices are coupled in some way.

Computing device 100 may communicate with presence-sensitive display 252 via a communication channel 264A. Computing device 100 may communicate with communication unit 254 via a communication channel 264B. Communication channels 262A, 262B may each include a system bus or another suitable connection. Although the example of FIG. 3 shows computing device 100, presence-sensitive display 252, and communication unit 254 as being separate, computing device 100, presence-sensitive display 252, and/or communication unit 254 may be integrated into a single device.

In the example of FIG. 3, presence-sensitive display 252 includes a display device 266 and a presence-sensitive input device 268. Display device 266 may display graphical content based on data received from computing device 100. Presence-sensitive input device 268 may determine one or more user inputs (e.g., continuous gestures, multi-touch gestures, single-touch gestures, etc.). Presence-sensitive input device 268 may use capacitive, inductive, and/or optical recognition techniques to determine the user inputs. Presence-sensitive display 252 may send indications of such user inputs to computing device 100 via communication channel 264A or another communication channel. In some examples, presence-sensitive input device 268 is physically positioned relative to display device 116 such that presence-sensitive input device 268 is able to detect the presence of an input object (e.g., a finger or a stylus) at a location on display device 266 that displays a graphical element when a user positions the input object at the location on display device 266 that displays the graphical element.

Communication unit 254 may have the functionality of communication unit(s) 204. This disclosure describes the functionality of communication unit 44 with regard to FIG. 2. Examples of communication unit 254 may include network interface cards, Ethernet cards, optical transceivers, radio frequency transceivers, Bluetooth, 3G, and WiFi radios, Universal Serial Bus (USB) interfaces, or other types of devices that are able to send and receive data. When computing device 100 outputs data for display at the one or more remote devices (such as projector 256, projection screen 258, mobile device 260, and visual display device 262), computing device 100 may output the data to a communication unit of computing device 100, such as communication unit 254. Communication unit 254 may send the data to one or more of the remote devices. The one or more remote devices may display graphical content based at least in part on the data.

Communication unit 254 may send and receive data using various communication techniques. In the example of FIG. 3, a network link 270A operatively couples communication unit 254 to an external network 272. Network links 270B, 270C, and 270D may operatively couple each of the remote devices to external network 272. External network 272 may include network hubs, network switches, network routers, or other types of devices that exchange information between computing device 100 and the remote devices illustrated in FIG. 3. In some examples, network links 270A-270D may be Ethernet, ATM or other wired and/or wireless network connections.

In some examples, communication unit 254 may use direct device communication 274 to communicate with one or more of the remote devices included in FIG. 3. Direct device communication 274 may include communications through which computing device 100 sends and receives data directly with a remote device, using wired or wireless communication. That is, in some examples of direct device communication 274, data sent by computing device 100 may not be forwarded by one or more additional devices before being received at the remote device, and vice-versa. Examples of direct device communication 274 may include Bluetooth, Near-Field Communication, Universal Serial Bus, WiFi, infrared, etc. One or more of the remote devices illustrated in FIG. 3 may be operatively coupled with communication unit 254 by communication links 276A-276D. In some examples, communication links 276A-276D may be connections using Bluetooth, Near-Field Communication, Universal Serial Bus, infrared, etc. Such connections may be wireless and/or wired connections.

In the example of FIG. 3, projector 256 receives data from computing device 100. Projector 256 may project graphical content based on the data onto projection screen 258. The example of FIG. 3 shows projector 256 as a tabletop projector and shows projection screen 258 as a freestanding screen. In other examples, computing device 100 may output data for display at other types of projection devices, such as electronic whiteboards, holographic display devices, and other suitable devices for displaying graphical content.

In some examples, projector 256 may determine one or more user inputs (e.g., continuous gestures, multi-touch gestures, single-touch gestures, etc.) at projection screen 258 and send indications of such user input to computing device 100. In such examples, projector 256 may use optical recognition or other suitable techniques to determine the user input. Projection screen 258 (e.g., an electronic whiteboard) may display graphical content based on data received from computing device 100.

Mobile device 260 and visual display device 262 may each have computing and connectivity capabilities and may each receive data that computing device 100 output for display. Examples of mobile device 260 may include e-reader devices, convertible notebook devices, hybrid slate devices, etc. Examples of visual display device 262 may include televisions, computer monitors, etc. As shown in FIG. 3, projection screen 258 may include a presence-sensitive display 278, mobile device 260 may include a presence-sensitive display 280, and visual display device 262 may include a presence-sensitive display 282. Presence-sensitive displays 278, 280, 282 may have some or all of the functionality described in this disclosure for UI device 4. In some examples, presence-sensitive displays 278, 280, 282 may include functionality in addition to the functionality of UI device 4. Presence-sensitive displays 278, 280, 282 may receive data from computing device 100 and may display graphical content based on the data. In some examples, presence-sensitive displays 278, 280, 282 may determine one or more user inputs (e.g., continuous gestures, multi-touch gestures, single-touch gestures, etc.) and send indications of such user input to computing device 100. Presence-sensitive displays 278, 280, and/or 282 may use capacitive, inductive, optical recognition techniques and/or other techniques to determine the user input.

In some examples, computing device 100 does not output data for display at presence-sensitive display 252. In other examples, computing device 100 may output data for display such that both presence-sensitive display 252 and the one or more remote devices display the same graphical content. In such examples, each respective device may display the same graphical content substantially contemporaneously. In such examples, the respective devices may display the graphical content at different times due to communication latency. In other examples, computing device 100 may output data for display such that presence-sensitive display 252 and the one or more remote devices display different graphical content.

In the example of FIG. 3, computing device 100 may output, for display at a display device, such as display device 266, projector 256, mobile device 260, visual display device, etc., a GUI that includes a first version of an element. Furthermore, computing device 100 may receive, from an input device such as presence-sensitive input device 268 or presence-sensitive displays 278, 280, 282, etc., an indication of a user input. In response to determining that the user input corresponds to a rotating movement of an input point relative to a fixed region (e.g., a fixed region on the input device), computing device 100 may output, for display at the display device, a second version of the element in place of the first version of the element, the second version of the element being larger than the first version of the element.

FIGS. 4A-4C are conceptual diagrams illustrating example GUIs that computing device 100 of FIG. 1 may output for display at presence-sensitive display 103, in accordance with one or more aspects of this disclosure. In particular, FIGS. 4A-4C illustrate examples in which computing device 100 outputs GUIs that include interface elements in expanded and collapsed states in response to receiving user input in the form of rotating gestures.

In the example of FIG. 4A, computing device 100 outputs a GUI 302A for display at presence-sensitive display 103. GUI 302A includes an interface element 310A. In other examples, GUI 302A may include other interface elements (e.g., other expandable elements), as well as any other objects or information.

Interface element 310A may expand or collapse in a vertical direction indicated by arrow 312A. In the example of FIG. 4A, the region of presence-sensitive display 103 occupied by the collapsed version of interface element 310A is shown by a solid line rectangle. The region of presence-sensitive display 103 occupied by the expanded version of interface element 310A is shown by the solid line rectangle plus the dashed-line rectangle.

Computing device 100 may output GUI 302A such that interface element 310A expands or collapses in response to receiving indications of user inputs (e.g., entered at presence-sensitive display 103) that correspond to various rotating movements. For example, computing device 100 may output GUI 302A such that interface element 310A expands or collapses in response to determining that a user input corresponds to a gesture that includes a rotating movement of an input point from region 314A to region 314B, or vice versa. In the example of FIG. 4A, presence-sensitive display 103 may detect the rotating movement. In this example, computing device 100 receives an indication that the input point rotates relative to a region 316, which may be considered a fixed region on presence-sensitive display 103. In some examples, the gesture may include a stationary input point at region 316.

Alternatively, as also shown in the example of FIG. 4A, computing device 100 may output GUI 302A such that interface element 310A expands or collapses in response to receiving an indication of a user input that corresponds to a gesture that includes a rotating movement of a first input point from region 318A to region 318B, and a rotating movement of a second input point from region 320A to region 320B. In this example, the first and second input points both rotate, in a clockwise direction, relative to a region 322, which may be considered a fixed region. In other examples, the first input point may rotate, in a counterclockwise direction, from region 318B to region 318A, and the second input point may rotate, in the counterclockwise direction, from region 320B to region 320A.

In the example FIG. 4B, computing device 100 outputs a GUI 302B for display at presence-sensitive display 103. Computing device 100 may, in response to receiving indications of user inputs (e.g., entered at presence-sensitive display 103) that correspond to rotating gestures, output an interface element 310B such that interface element 310B expands or collapses in a horizontal (i.e., left/right) direction shown by arrow 312B. In the example of FIG. 4B, the region of presence-sensitive display 103 occupied by the collapsed version of interface element 310B is shown by a solid line rectangle. The region of presence-sensitive display 103 occupied by the expanded version of interface element 310B is shown by the solid line rectangle plus the dashed-line rectangle.

In the example FIG. 4C, computing device 100 outputs a GUI 302C for display at presence-sensitive display 103. Computing device 100 may, in response to receiving indications of user inputs (e.g., entered at presence-sensitive display 103) that correspond to rotating gestures, output an interface element 310C such that interface element 310C expands and collapses in a diagonal direction as shown by arrow 312C. In the example of FIG. 4C, the region of presence-sensitive display 103 occupied by the collapsed version of interface element 310C is shown by a solid line rectangle. The region of presence-sensitive display 103 occupied by the expanded version of interface element 310C is shown by the solid line rectangle plus the dashed-line rectangle.

In the examples of FIGS. 4B and 4C, computing device 100 may output expanded or collapsed versions of interface elements 310B and 310C in response to receiving indications of rotating gestures of the type shown in FIG. 4A. Moreover, in other examples, computing device 100 may output interface elements 310A, 310B, and 310C (collectively, “interface elements 310”) such that interface elements 310 expand or collapse in directions other than those shown in FIGS. 4A-4C. For example, computing device 100 may output interface elements 310 such that interface elements 310A-310C expand and collapse in directions that include any combination of upward/downward, left/right, and diagonal directions. Furthermore, although interface elements 108 of FIG. 1 and interface elements 310 of FIGS. 4A-4C are depicted as having rectangular geometries, one or more of interface elements 108 and 310 may have different geometries, such as square, circular, oval, as well as any number of other geometries. Additionally, while interface elements 108 and 310 are depicted as being located in particular regions and locations within the corresponding ones of GUIs 102, 302A, 302B, and 302C, each of interface elements 108 and 310, both in their collapsed as well as expanded states, may be located elsewhere within GUIs 102 and 302A-302C.

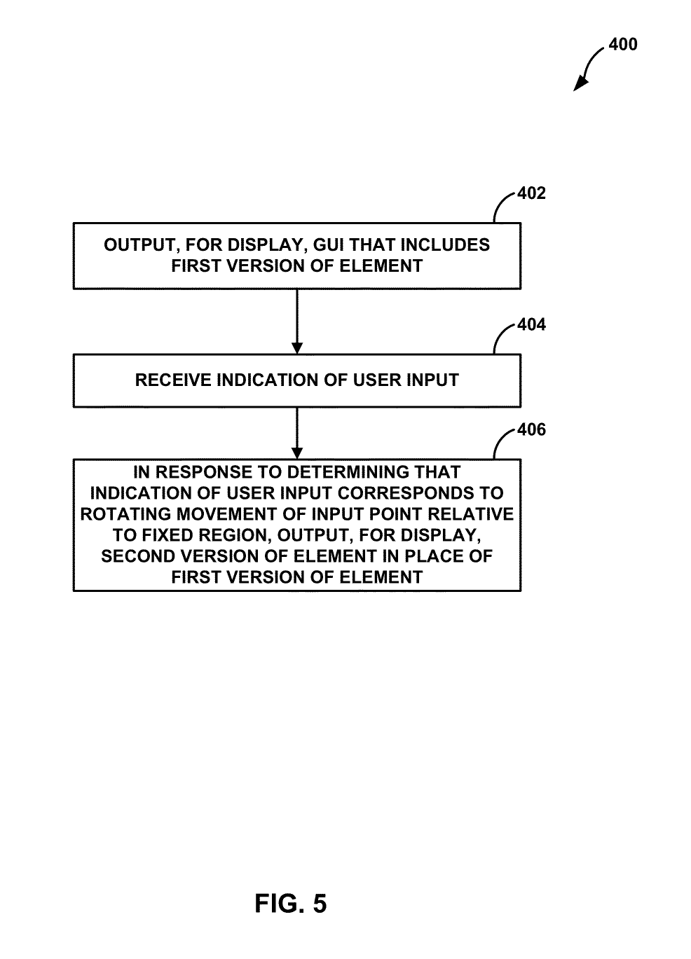

FIG. 5 is a flowchart illustrating an example process 400 that computing device 100 of FIG. 1 may perform, in accordance with one or more aspects of this disclosure. In process 400, computing device 100 may output, for display at a display device (e.g., presence-sensitive display 103), a GUI that includes a first version of an element (402). Additionally, computing device 100 may receive an indication of a user input (404). The user input may be detected by presence-sensitive display 103. Furthermore, in response to determining that the user input corresponds to a rotating movement of an input point relative to a fixed region (i.e., a rotating gesture), computing device 100 may output, for display at the display device, a second version of the element in place of the first version of the element, the second version of the element being larger than the first version of the element (406).

In other examples, computing device 100 may further receive additional indications of user inputs, e.g., indications of one or more subsequent gestures, which may also include a rotating movement of one or more input points relative to a fixed region. In particular, as one example, the above-described user input may be a first user input, the above-described input point may be a first input point, and the above-described fixed region may be a first fixed region. In this example, computing device 100 may further receive an indication of a second user input. The second user input may be detected by presence-sensitive display 103. Also in this example, computing device 100 may still further, in response to determining that the second user input corresponds to a rotating movement of a second input point relative to a second fixed region, output, for display at presence-sensitive display 103, the first version of the element in place of the second version of the element. In other words, computing device 100 may collapse the second version of the element to display the first version of the element.

In the above-described example, the second input point may rotate relative to the second fixed region in a direction that is reversed relative to a direction in which the first input point rotates relative to the first fixed region, in some cases. In other words, upon expanding the element, computing device 100 may further collapse the expanded element using a similar, albeit reversed gesture.

Additionally, in some examples, the first fixed region and the second fixed region may include a same region, or different regions, of presence-sensitive display 103. Stated another way, the first gesture may include the first rotating movement of the first input point relative to the first fixed region on presence-sensitive display 103, and the second gesture may include the second rotating movement of the second input point relative to the second fixed region on presence-sensitive display 103, such that the first and second gestures are performed relative to the same or different regions on presence-sensitive display 103. Moreover, in some examples, the first gesture and the second gesture may be a single continuous gesture. In other words, the first input point and the second input point may be a same input point.

In this manner, computing device 100 may, in some cases, implement process 400 to enable a user to more easily expand or collapse one or more interface elements of a GUI output by computing device 100 for display at presence-sensitive display 103. As previously described, in such cases, performing other expansion or collapsing gestures (e.g., two-finger “pinch-out” gestures, or equivalent gestures, that require placement of two or more fingers or styli within a relatively short height, width, or other dimension of a graphical element that corresponds to the interface element) may be difficult or impractical.

In particular, computing device 100 represents an example of a computing device configured to perform a method including the steps of outputting, by the computing device, a GUI for display at a presence-sensitive display, the GUI including a first version of an element, receiving, by the computing device, an indication of a user input entered at the presence-sensitive display, and, in response to determining that the user input corresponds to a gesture that includes a rotating movement of an input point relative to a fixed region on the presence-sensitive display, outputting, by the computing device and for display at the presence-sensitive display, a second version of the element in place of the first version of the element, the second version of the element being larger than the first version of the element.

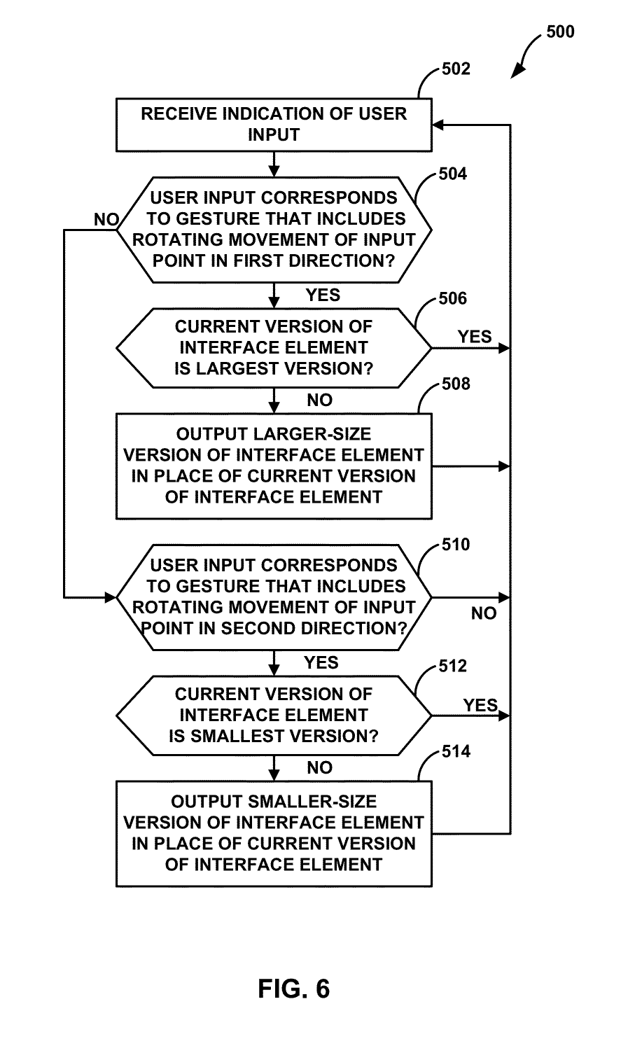

FIG. 6 is a flowchart illustrating another example process 500 that computing device 100 of FIG. 1 may perform, in accordance with one or more aspects of this disclosure. In particular, process 500 may be a specific example of process 400 shown in FIG. 5 and described in detail above.

In a similar manner as described above, in this example, computing device 100 may output a GUI (e.g., GUI 102) for display at presence-sensitive display 103, wherein the GUI includes an interface element (e.g., any one of interface elements 108 and 310).

In process 500, computing device 100 may initially receive an indication of a user input (502). For example, as previously described, computing device 100 may receive the indication of the user input from presence-sensitive display 103 (e.g., wherein the user input is entered at presence-sensitive display 103). As one example, as also previously described, presence-sensitive display 103 may detect the user input in the form of a gesture that includes a rotating movement of an input point relative to a fixed region on presence-sensitive display 103.

In this example, computing device 100 may further determine whether the user input corresponds to a gesture that includes a rotating movement of an input point (e.g., relative to a fixed region on presence-sensitive display 103) in a first direction (504). For example, in the event the user input corresponds to such a gesture (“YES” branch of 504), computing device 100 may further determine whether a current version of the interface element is a largest version of the interface element (506).

In the event the current version of the interface element is the largest version (“YES” branch of 506), computing device 100 may perform no modifications to the interface element. For example, in such instances, the gesture, and, in particular, the first direction of the rotating movement of the input point may correspond to an expansion gesture, and the interface element may already be in a fully-expanded state. In these examples, computing device 100 may receive additional indications of a user input (i.e., return to step 502). Alternatively, in the event the current version of the interface element is not the largest version (“NO” branch of 506), computing device 100 may output a larger-size version of the interface element in place of the current version of the interface element (508). Subsequently, computing device 100 may once again receive additional indications of a user input (i.e., return to step 502).

Alternatively, in the event the user input does not correspond to such a gesture (i.e., a gesture that includes a rotating movement of an input point in a first direction) (“NO” branch of 504), computing device 100 may make additional determinations. For example, computing device 100 may further determine whether the user input corresponds to another gesture that includes a rotating movement of an input point (e.g., relative to a fixed region on presence-sensitive display 103) in a second direction (510). In this example, in the event the user input corresponds to such a gesture (“YES” branch of 510), computing device 100 may further determine whether the current version of the interface element is a smallest version of the interface element (512).

In the event the current version of the interface element is the smallest version (“YES” branch of 512), computing device 100 may once again perform no modifications to the interface element. For example, in these cases, the gesture, and, in particular, the second direction of the rotating movement of the input point may correspond to a collapsing gesture, and the interface element may already be in a collapsed state. In these examples, computing device 100 may once again receive additional indications of a user input (i.e., return to step 502). Alternatively, in the event the current version of the interface element is not the smallest version (“NO” branch of 512), computing device 100 may output a smaller-size version of the interface element in place of the current version of the interface element (514). Subsequently, computing device may once again receive additional indications of a user input (i.e., return to step 502).

In this manner, computing device 100 may determine, based on an indication of a user input entered at presence-sensitive display 103, whether the user input corresponds to an expansion gesture or a collapsing gesture, determine whether a particular interface element is in an expanded or collapsed state, and expand or collapse the interface element, based on the user input and the above-described determinations.

Techniques described herein may be implemented, at least in part, in hardware, software, firmware, or any combination thereof. For example, various aspects of the described embodiments may be implemented within one or more processors, including one or more microprocessors, DSPs, ASICs, FPGAs, or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described herein. In addition, any of the described units, modules, or components may be implemented together or separately as discrete but interoperable logic devices. Depiction of different features as modules or units is intended to highlight different functional aspects and does not necessarily imply that such modules or units are realized by separate hardware, firmware, or software components. Rather, functionality associated with one or more modules or units may be performed by separate hardware, firmware, or software components, or integrated within common or separate hardware, firmware, or software components.

The techniques described herein may also be embodied or encoded in an article of manufacture, including a computer-readable storage medium encoded with instructions. Instructions embedded or encoded in an article of manufacture, including an encoded computer-readable storage medium, may cause one or more programmable processors, or other processors, to implement one or more of the techniques described herein, such as when instructions included or encoded in the computer-readable storage medium are executed by the one or more processors. The computer-readable storage medium may include RAM, ROM, PROM, EPROM, EEPROM, flash memory, a hard disk, a compact disc ROM (CD-ROM), a floppy disk, a cassette, magnetic media, optical media, or other computer-readable media. Additional examples of the computer-readable storage medium include computer-readable storage devices, computer-readable memory devices, and tangible computer-readable media. In some examples, an article of manufacture may include one or more computer-readable storage media.

In some examples, the computer-readable storage medium may include non-transitory media. The term “non-transitory” may indicate that the storage media is tangible and is not embodied in a carrier wave or a propagated signal. In certain examples, the non-transitory storage medium may store data that can, over time, change (e.g., in RAM or cache).

Various examples have been described. These and other examples are within the scope of the following claims.

What is claimed is:

1. A method comprising:
outputting, by a computing device and for display, a graphical user interface that includes a first version of an element;
receiving, by the computing device, an indication of a user input; and
in response to determining that the user input corresponds to a gesture comprising a rotating movement of an input point relative to a fixed region, outputting, by the computing device and for display, a second version of the element in place of the first version of the element, the second version of the element being larger than the first version of the element.

2. The method of claim 1,
wherein the first version of the element exclusively includes a first content portion; and
wherein the second version of the element includes a second content portion in addition to the first content portion.

3. The method of claim 1, wherein the input point is a first input point, and wherein the gesture further comprises a second input point that remains substantially at the fixed region while the first input point rotates relative to the fixed region.

4. The method of claim 3, wherein the first input point rotates from a region that corresponds to the first version of the element to another region.

5. The method of claim 3, wherein the first input point rotates within a region that corresponds to the first version of the element.

6. The method of claim 1, wherein the input point is a first input point, and wherein the user input further corresponds to a rotating movement of a second input point relative to the fixed region.

7. The method of claim 6, wherein one or more of the first input point and the second input point rotate from a region that corresponds to the first version of the element to another region.

8. The method of claim 6, wherein one or more of the first input point and the second input point rotate within a region that corresponds to the first version of the element.

9. The method of claim 1, wherein the fixed region is within a region that corresponds to the first version of the element.

10. The method of claim 1, wherein the fixed region is outside of a region that corresponds to the first version of the element.

11. The method of claim 1, wherein the rotating movement of the input point relative to the fixed region is in one of a clockwise direction and a counterclockwise direction.

12. The method of claim 1, wherein the second version of the element is larger than the first version of the element in at least one of: a vertical direction, a horizontal direction, and a diagonal direction.

13. The method of claim 1, wherein the first version of the element and the second version of the element comprise content that notifies a user of an event.

14. The method of claim 1, wherein the user input is a first user input, the input point is a first input point, the fixed region is a first fixed region, and the method further comprises:
receiving, by the computing device, an indication of a second user input; and
in response to determining that the second user input corresponds to a rotating movement of a second input point relative to a second fixed region, outputting, by the computing device and for display, the first version of the element in place of the second version of the element.

15. The method of claim 14, wherein the second input point rotates relative to the second fixed region in a direction that is reversed relative to a direction in which the first input point rotates relative to the first fixed region.

16. The method of claim 14, wherein the first fixed region and the second fixed region comprise a same region.

17. The method of claim 14, wherein the first input point and the second input point are a same input point.

18. A computing device comprising one or more processors configured to:
output a graphical user interface for display at a display device, the graphical user interface including at least a first version of an element;
receive an indication of a user input;
determine that the user input corresponds to a particular gesture that comprises a rotating movement of an input point relative to a fixed region; and
in response to determining that the user input corresponds to the rotating movement of the input point relative to the fixed region, output, for display, a second version of the element in place of the first version of the element, the second version of the element being larger than the first version of the element in at least one of: a vertical direction, a horizontal direction, and a diagonal direction.

19. The computing device of claim 18, wherein the user input is a first user input, the particular gesture is a first gesture, the input point is a first input point, the fixed region is a first fixed region, and the one or more processors are configured to:
receive an indication of a second user input;
determine that the second user input corresponds to a second gesture, the second gesture comprising a rotating movement of a second input point relative to a second fixed region; and
output, in response to determining that the second user input corresponds to the second gesture and for display, the first version of the element in place of the second version of the element.

20. A non-transitory computer-readable storage medium comprising instructions that, when executed by one or more processors of a computing device, cause the computing device to:
output, for display, a graphical user interface that includes a first version of an element;
receive an indication of a first user input, the first user input corresponding to a first rotating movement of a first input point relative to a first fixed region in a first direction;
output, in response to receiving the indication of the first user input and for display by the display device, a second version of the element in place of the first version of the element, the second version of the element having a size that is greater than a size of the first version of the element;
after outputting the second version of the element, receive an indication of a second user input, the second user input corresponding to a second rotating movement of a second input point relative to a second fixed region in a second direction; and
output, in response to receiving the indication of the second user input and for display, the first version of the element in place of the second version of the element.
